(19) United States
(12) Patent Application Publication
(10) Pub. No.: US 2011/0276787 A1
(43) Pub. Date: Nov. 10, 2011

(54) MULTITHREAD PROCESSOR, COMPILER APPARATUS, AND OPERATING SYSTEM APPARATUS

(75) Inventors: Yoshihiro KOGA, Osaka (JP); Taketo HEISHI, Osaka (JP)

(73) Assignee: PANASONIC CORPORATION, Osaka (JP)

(21) Appl. No.: 13/186,818

(22) Filed: Jul. 20, 2011

Related U.S. Application Data
(63) Continuation of application No. PCT/JP2010/001931, filed on Mar. 18, 2010.

(30) Foreign Application Priority Data
May 28, 2009 (JP) 2009-129607

(51) Int. Cl. G06F 9/30

(52) U.S. Cl. 712/215; 712/E09.016

(57) ABSTRACT

A multithread processor for executing, in parallel, instructions included in a plurality of threads includes: a calculating group including a plurality of calculators each of which is for executing an instruction; instruction grouping units which classify, for each thread, the instructions included in the thread into groups each of which includes instructions that are simultaneously executable by the calculators; a thread selecting unit which selects, per execution cycle of the multithread processor, a thread including instructions to be issued to the calculators, from among the threads, by controlling execution frequency for executing the instructions included in the threads; and an instruction issuing unit which issues, to the calculators, per execution cycle of the multithread processor, the instructions classified into each of the groups and being among the instructions included in the thread selected by the thread selecting unit.

### CROSS REFERENCE TO RELATED APPLICATION

This is a continuation application of PCT application No. PCT/JP2010/001931 filed on Mar. 18, 2010, designating the United States of America.

### BACKGROUND OF THE INVENTION

(1) Field of the Invention

The present invention relates to a multithread processor and the like which executes a plurality of threads in parallel, and relates particularly to a multithread processor which increases efficiency in executing each thread by controlling the timing for executing instructions included in each thread.

(2) Description of the Related Art

In recent years, in the field of audio-visual (AV) processing, a new codec, a new scheme, and so on have continuously been released, with needs for AV processing using software growing. This has dramatically increased processor performance required for AV systems and so on. In addition, as software to be executed has become more multitasking, many multithread processors using a multithreading technique of simultaneously executing a plurality of threads have been developed.

In a conventional multithread processor, for example, the following techniques are well known: fine-grained multithreading which is a technique of switching, per execution cycle of the multithread processor, the thread to be executed (for example, see Patent Reference 1: Japanese Unexamined Patent Application Publication No. 2008-123045 (FIG. 6, and so on)); or simultaneous multithreading (SMT) which is a technique of simultaneously executing a plurality of threads in an execution cycle as represented by the Intel hyper-threading technology (for example, see Non-Patent Reference 1: Intel hyper-threading technology, Internet <URL: http://www.intel.com/jp/technology/hyperthread/> (searched on Feb. 16, 2009)).

### SUMMARY OF THE INVENTION

However, in the conventional multithread processor, when there is competition between threads for a calculating resource, a significant decrease may occur in efficiency in locally executing another thread which is inferior in terms of thread priority that is specified by a user or for implementing the multithread processor.

In addition, when there is an imbalance between the number of instructions in the respective threads and the number of calculating resources, there is a possibility of being unable to achieve the execution efficiency expected from multithread operation. For example, when attempting to continuously issue two instructions and three instructions that are included, respectively, in two threads, to a processor having a calculating resource capable of executing four instructions at the same time, a total of five instructions are included in the two threads. Thus, these two threads cannot be executed at the same time, and only the instruction in one of the two threads is executed. Accordingly, one or two calculating resources remain unused and wasted, causing a problem of efficiency decrease in thread execution.

An object of the present invention, conceived to solve the problem above, is to provide a multithread processor which is highly efficient in thread execution, and a compiler apparatus and an operating system apparatus for the multiprocessor.

A multithread processor according to an aspect of the present invention is a multithread processor for executing, in parallel, instructions included in a plurality of threads, and the multithread processor includes: a plurality of calculators each of which is for executing an instruction; a grouping unit which classifies, for each of the threads, the instructions included in the thread into groups each of which includes instructions that are simultaneously executable by the calculators; a thread selecting unit which selects, per execution cycle of the multithread processor, a thread including instructions to be issued to the calculators, from among the threads, by controlling execution frequency of executing the instructions included in the threads; and an instruction issuing unit which issues, to the calculators, per execution cycle of the multithread processor, the instructions classified into each of the groups by the grouping unit and being among the instructions included in the thread selected by the thread selecting unit.

According to the configuration described above, it is possible to prevent, through control of execution frequency for executing a plurality of threads, significant decrease in local execution efficiency of a thread that is inferior in terms of priority among treads that is specified by the user or for implementing the multithread processor. In addition, this also allows controlling execution frequency of the plurality of threads so as to efficiently use the calculating resources, thus allowing balancing the number of instructions in each thread and the number of calculating resources, to achieve efficient use of the calculating resources. With this, it is possible to provide a multithread processor having high thread execution efficiency.

Preferably, the multithread processor described above further includes an instruction number specifying unit which specifies, for each of the threads, a maximum number of instructions to be classified into each of the groups by the grouping unit, and the grouping unit classifies the instructions into each of the groups such that the number of the instructions in each of the groups does not exceed the maximum number of instructions that is specified by the instruction number specifying unit.

With this configuration, it is possible to balance the number of instructions in each thread and the number of calculating resources, thus allowing efficient use of the calculating resources.

More preferably, the instruction number specifying unit specifies the maximum number of instructions according to a value that is set for a register.

With this configuration, it is possible to control the maximum number of instructions for each given range of the program by updating, while keeping an instruction set system, the set value of the register using the program, thus allowing optimization of execution efficiency.

In addition, the instruction number specifying unit may specify the maximum number of instructions according to an instruction for specifying the maximum number of instructions to be included in the threads.

With this configuration, it is possible to change settings at higher speed due to reduced address setting and memory access, as compared to the case of specifying the maximum number of instructions according to the value set for the register. In addition, since this allows changing the settings at higher speed, it is possible to control the maximum number of instructions for each given, more detailed range without caring about overhead loss, thus allowing optimization of execution efficiency.

More preferably, the thread selecting unit includes an execution interval specifying unit which specifies, for each of the threads, an execution cycle interval for executing the instructions in the calculators, and the thread selecting unit selects each of the threads according to the execution cycle interval specified by the execution interval specifying unit.

With this configuration, it is possible to prevent a thread having higher priority from occupying a calculating resource for a longer time, thus allowing preventing local execution of a thread having low priority from being stopped.

Preferably, the execution interval specifying unit specifies the execution cycle interval according to a value that is set for a register.

With this configuration, by updating, while keeping the instruction set system, the setting value of the register using the program, it is possible to prevent, for each given range of the program, the calculating resources from being occupied, thus increasing execution efficiency of another thread.

In addition, the execution interval specifying unit may specify the execution cycle interval in accordance with an instruction for specifying the execution cycle interval, the instruction being included in each of the threads.

With this configuration, it is possible to change the settings at higher speed due to reduced address setting and memory access as compared to the case of specifying execution cycle intervals according to the value that is set to the register. In addition, since this allows the settings at higher speed, it is possible to prevent the calculating resources from being occupied, for each given, more detailed range of the program, without caring about overhead loss, thus allowing optimization of thread execution efficiency.

More preferably, the thread selecting unit includes an issuance interval suppressing unit which suppresses a thread from which an instruction causing competition between more than one thread for at least one of the calculators has been issued, so as to inhibit execution of the instruction during a given number of execution cycles.

With this configuration, unlike the method of collectively controlling the execution cycle, it is possible to control only the minimum instruction. This allows efficiently diverting the calculating resources to another thread without decreasing execution efficiency.

A compiler apparatus according to another aspect of the present invention is a compiler apparatus which is for converting a source program into an executable code and is used for a multithread processor which executes, in parallel, instructions included in a plurality of threads, and the compiler apparatus includes: a directive obtaining unit which obtains a directive for multithread control from a programmer; and a control code generating unit which generates, according to the directive, a code for controlling an execution mode of the multithread processor.

With this configuration, it is possible to control the execution mode of the multithread processor in accordance with the directive given by a programmer for the multithread control. This allows generating the code for the multithread processor having higher thread execution efficiency.

An operating system apparatus according to another aspect of the present invention is an operating system apparatus for a multithread processor which executes, in parallel, instructions included in a plurality of threads, and the operating system apparatus includes a system call processing unit which processes a system call which allows controlling an execution mode of the multithread processor, according to a directive for multithread control from a programmer.

With this configuration, it is possible to control the execution mode of the multithread processor in accordance with the directive given by the programmer for the multithread control. This allows processing a system call for the multithread processor having higher thread execution efficiency.

Note that the present invention can be realized not only as a multithread processor including such a characteristic processing unit but also as an information processing method which includes, as steps, such a characteristic processing unit included in the multithread processor. In addition, the present invention can also be realized as a program which causes a computer to execute such characteristic steps included in the information processing method. In addition, it goes without saying that such a program can be distributed through a non-volatile recording medium such as a compact disc-read only memory (CD-ROM) and a communication network such as the Internet.

With the multithread processor according to an implementation of the present invention, even when there is competition between threads for a calculating resource, it is possible to prevent significant decrease in efficiency in locally executing a thread that is inferior in terms of priority among threads that is specified by the user or for implementing the multithread processor. In addition, it is possible to achieve a balance between the number of instructions in each thread and the number of calculating resources, thus allowing efficient use of the calculating resources. This allows providing the multithread processor having high thread execution efficiency.

### FURTHER INFORMATION ABOUT TECHNICAL BACKGROUND TO THIS APPLICATION

The disclosure of Japanese Patent Application No. 2009-129607 filed on May 28, 2009 including specification, drawings and claims is incorporated herein by reference in its entirety.

The disclosure of PCT application No. PCT/JP2010/001931 filed on Mar. 18, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram of a multithread processor according to a first embodiment of the present invention;

FIG. 2 is a block diagram of a thread selecting unit according to the first embodiment of the present invention;

FIG. 3 is a flowchart showing an operation of the multithread processor according to the first embodiment of the present invention;

FIG. 4 is a flowchart of thread selection processing according to the first embodiment of the present invention;

FIG. 5 is a block diagram showing a configuration of a compiler according to a second embodiment of the present invention;

FIG. 6 is a diagram showing a list of directives for multithread control that can be accepted by the compiler according to the second embodiment of the present invention;

FIG. 7 is a diagram showing an example of a source program using a “focus section directive”;

FIG. 8 is a diagram showing an example of a source program using an “unfocus section directive”;

FIG. 9 is a diagram showing an example of a source program using an “instruction level parallelism directive”;

FIG. 10 is a diagram showing an example of a source program using a “multithread execution mode directive”;

FIG. 11 is a diagram showing an example of a source program using a “response ensuring section directive”;

FIG. 12 is a diagram showing an example of a source program using a “stall insertion frequency directive”;

FIG. 13 is a diagram showing an example of a source program using a “calculator release frequency directive”;

FIG. 14 is a diagram showing an example of a source program using a “tightness detection directive”;

FIG. 15 is a diagram showing an example of a source program using an “execution cycle expected value directive”; and

FIG. 16 is a block diagram showing a configuration of an operating system according to the second embodiment of the present invention.

### DESCRIPTION OF THE PREFERRED EMBODIMENT(S)

Hereinafter, embodiments of a multithread processor and so on will be described with reference to the drawings. Note that in the embodiments the constituent elements assigned with the same numerical references perform the same operations, and therefore the same description will not be repeated in some cases.

### First Embodiment

According to the embodiments, the following will describe: a multithread processor which increases instruction execution efficiency by controlling execution of instructions; restricting the number of the instructions; specifying, by a register, the number of the instructions to be restricted; specifying, according to the instruction, the number of the instructions to be restricted; specifying execution cycle intervals; specifying the execution cycle intervals by the register; specifying the execution cycle intervals according to the instruction; and suppressing issuance intervals for an instruction having constraint on resources.

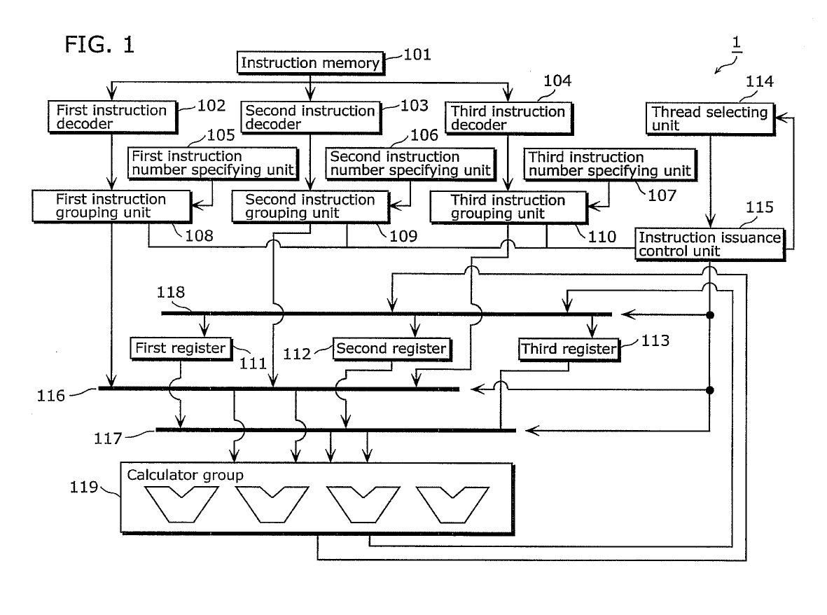

FIG. 1 is a block diagram showing a configuration of a multithread processor according to the present embodiment. Note that the present embodiment assumes a multithread processor capable of executing three threads in parallel.

The multithread processor 1 includes: an instruction memory 101; a first instruction decoder 102; a second instruction decoder 103; a third instruction decoder 104, a first instruction number specifying unit 105; a second instruction number specifying unit 106; a third instruction number specifying unit 107; a first instruction grouping unit 108; a second instruction grouping unit 109; a third instruction grouping unit 110; a first register 111; a second register 112; a third register 113; a thread selecting unit 114; an instruction issuance control unit 115; a thread selector 116; thread register selectors 117 and 118; and a calculator group 119.

The instruction memory 101 is memory which holds an instruction to be executed by the multithread processor 1, and holds an instruction stream of three threads that are to be executed independently from each other.

Each of the first instruction decoder 102, the second instruction decoder 103, and the third instruction decoder 104 reads, from the instruction memory 101, instructions of a thread that is different from the other threads, and decodes the instructions that are read.

Each of the first instruction number specifying unit 105, the second instruction number specifying unit 106, and the third instruction number specifying unit 107 specifies the number of simultaneously executable instructions that is used for classifying, into groups each including simultaneously executable instructions, the instructions decoded by a corresponding one of the first instruction decoder 102, the second instruction decoder 103, and the third instruction decoder 104. The present embodiment will be described assuming an upper limit on the number of instructions to be 3. For the method of specifying the number of instructions, the instruction stream in each thread may include a dedicated instruction for specifying the number of instructions, so as to specify the number of instructions through execution of the dedicated instruction. Alternatively, a dedicated register for setting the number of instructions may be provided, so as to change a value of the dedicated register in the instruction stream in each thread and specify the number of instructions.

In the case of specifying the number of instructions by executing the dedicated instruction, no overhead loss is caused by address setting or register access. This allows changing the number of instructions at higher speed. In addition, by previously inserting the dedicated instruction into the thread at a plurality of points, it is possible to specify different number of instructions in a plurality of instruction ranges in the thread. In the case of setting the number of instructions for the dedicated register, it is possible to control, while keeping the instruction set system, the number of instructions that are to be simultaneously executed.

By changing the specification of the number of instructions according to the balance between the number of calculating resources and the number of simultaneously executable threads, it is possible to increase instruction execution efficiency. For example, in the case where four calculators are provided and two threads are simultaneously executable, when the upper limit on the number of instructions is set to 2, two calculators are supposed to be used for each of the two threads. However, by setting the number of instructions to 3, a maximum of three instructions are classified into one instruction group for each thread. As a result, for example, when the instruction group in one of the two threads includes three instructions, and the instruction group in the other thread includes two instructions, it is possible to execute only one of the threads, and this results in an unused calculator, thus decreasing thread execution efficiency.

Each of the first instruction grouping unit 108, the second instruction grouping unit 109, and the third instruction grouping unit 110 classifies, into an simultaneously executable instruction group, the instructions decoded by a corresponding one of the first instruction decoder 102, the second instruction decoder 103, and the third instruction decoder 104. Note that in the grouping, the instructions are classified into groups such that the number of instructions in each group does not exceed the number of instructions that is set by each of the first instruction number specifying unit 105, the second instruction number specifying unit 106, and the third instruction number specifying unit 107.

The first register 111, the second register 112, and the third register 113 are register files used for calculation according to the instruction of each thread.

The thread selecting unit 114 holds the setting information related to thread priority, and selects a thread to be executed according to a thread execution status. It is assumed that thread priority is predetermined.

The instruction issuance control unit 115 controls the thread selector 116 and the thread register selectors 117 and 118, so as to issue the thread selected by the thread selecting unit 114 to the calculator group 119. In addition, the instruction issuance control unit 115 notifies the thread selecting unit 114 of issued instruction information that is information on the thread issued to the calculator group 119. Note that the present embodiment assumes the number of simultaneously executable threads to be 2.

The thread selector 116 is a selector which selects an execution thread (a thread whose instruction is executed by the calculator group 119) in accordance with a directive from the instruction issuance control unit 115.

The thread register selectors 117 and 118, as with the thread selector 116, are selectors each of which selects a register that corresponds to the execution thread in accordance with the directive from the instruction issuance control unit 115.

The calculator group 119 includes a plurality of calculators such as adders or multipliers. Note that the present embodiment assumes the number of simultaneously executable calculators to be 4.

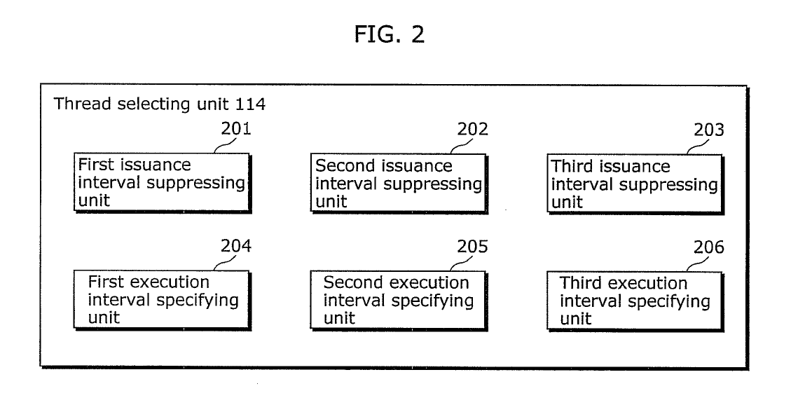

FIG. 2 is a block diagram showing a detailed configuration of the thread selecting unit 114 shown in FIG. 1.

The thread selecting unit 114 includes: a first issuance interval suppressing unit 201; a second issuance interval suppressing unit 202; a third issuance interval suppressing unit 203; a first execution interval specifying unit 204; a second execution interval specifying unit 205; and a third execution interval specifying unit 206.

When instructions which are not simultaneously executable due to the limitation on the number of calculators in the calculator group 119 and so on are issued from assigned threads, each of the first issuance interval suppressing unit 201, the second issuance interval suppressing unit 202, and the third issuance interval suppressing unit 203 subsequently suppresses a corresponding one of the threads so that a corresponding one of the instructions is not issued for a given period of time.

Each of the first execution interval specifying unit 204, the second execution interval specifying unit 205, and the third execution interval specifying unit 206 specifies thread execution intervals such that the instructions included in the assigned threads are executed at given intervals. For the method of specifying execution intervals, a dedicated instruction for specifying execution intervals may be included in each thread, and the execution intervals may be specified by executing the dedicated instruction. Alternatively, a dedicated register for setting the execution intervals may be provided, so as to specify the execution intervals by changing the value of the dedicated register in the instruction stream in each thread. By specifying the execution intervals, it is possible to prevent a thread having higher priority from occupying a resource for a long time, thus allowing preventing local execution of a thread having low priority from being stopped. In the case of specifying the execution intervals by executing the dedicated instruction, no overhead loss is caused by address setting or register access. In addition, by previously inserting the dedicated instruction into a plurality of points in the thread, it is possible to specify different execution intervals in a plurality of instruction ranges in the thread. In the case of setting execution intervals to the dedicated register, it is possible to control the execution intervals while keeping the instruction set system.

Note that each of the first issuance interval suppressing unit 201, the second issuance interval suppressing unit 202, the third issuance interval suppressing unit 203, the first execution interval specifying unit 204, the second execution interval specifying unit 205, and the third execution interval specifying unit 206 includes a down counter which decrements a value by one after each execution cycle.

Hereinafter, for convenience, the three threads are referred to as a thread A, a thread B, and a thread C. The thread A is executed using: the first instruction decoder 102, the first instruction number specifying unit 105, the first instruction grouping unit 108, the first register 111, the first issuance interval suppressing unit 201, and the first execution interval specifying unit 204. The thread B is executed using: the second instruction decoder 103, the second instruction number specifying unit 106, the second instruction grouping unit 109, the second register 112, the second issuance interval suppressing unit 202, and the second execution interval specifying unit 205. The thread C is executed using: the third instruction decoder 104, the third instruction number specifying unit 107, the third instruction grouping unit 110, the third register 113, the third issuance interval suppressing unit 203, and the third execution interval specifying unit 206.

Next, an operation of the multithread processor 1 will be described.

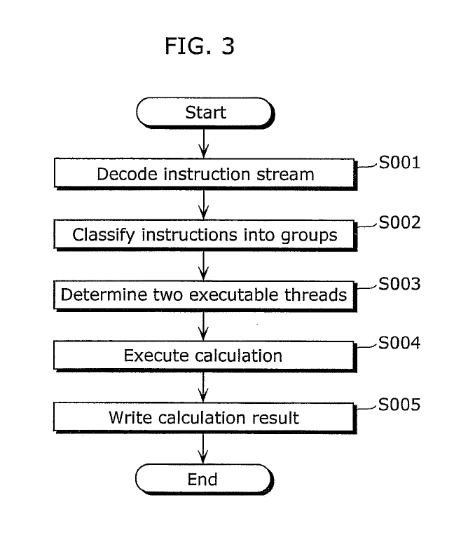

FIG. 3 is a flowchart showing an operation of the multithread processor 1.

The first instruction decoder 102, the second instruction decoder 103, and the third instruction decoder 104 decode, respectively, the thread A, the thread B, and the thread C that are stored in the instruction memory 101 (Step S001).

The first instruction grouping unit 108, by assuming, as the upper limit, the number of instructions that is specified by the first instruction number specifying unit 105, classifies an instruction stream of the thread A which is decoded by the first instruction decoder 102, into an instruction group including instructions that are simultaneously executable by the calculator group 119. Likewise, the second instruction grouping unit 109, by assuming, as the upper limit, the number of instructions that is specified by the second instruction number specifying unit 106, classifies an instruction stream in the thread B which is decoded by the second instruction decoder 103, into an instruction group including instructions that are simultaneously executable by the calculator group 119. In addition, the third instruction grouping unit 110, by assuming, as the upper limit, the number of instructions that is specified by the third instruction number specifying unit 107, classifies an instruction stream in the thread C which is decoded by the third instruction decoder 104, into an instruction group including instructions that are simultaneously executable by the calculator group 119 (Step S002).

The instruction issuance control unit 115 determines two executable threads, based on setting information related to thread priority held by the thread selecting unit 114 and information of the instructions classified into groups by the processing in step S002 (Step S003). Here, the subsequent description is based on an assumption that the threads A and C have been determined as executable threads.

The thread selector 116 selects the threads A and C as executable threads. In addition, the thread register selector 117 selects the first register 111 and the third register 113 which correspond to the threads A and C, respectively. The calculator group 119 executes calculation of the threads (threads A and C) selected by the thread selector 116, using the data stored in the registers (the first register 111 and the third register 113) selected by the thread register selector 117 (Step S004).

The thread register selector 118 selects the same register that is selected by the thread register selector 117 (the first register 111 and the third register 113). The calculator group 119 writes the result of the calculation performed on the threads (threads A and C) into the registers (the first register 111 and the third register 113) selected by the thread register selector 118 (Step S005).

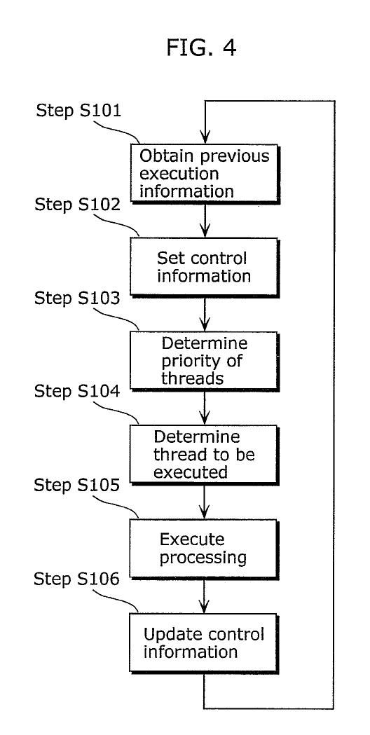

Next, thread selection processing performed by the thread selecting unit 114 and the instruction issuance control unit 115 will be described with reference to the flowchart in FIG. 4.

Note that in the present description, when an issuance interval suppression instruction that is to be described later is issued from the thread A, the first issuance interval suppressing unit 201 subsequently suppresses (prohibits) issuance of the issuance interval suppression instruction for a period of two machine cycles. Here, the issuance interval suppression instruction is an instruction which causes competition for the calculator between more than one thread. Likewise, when the issuance interval suppression instruction is issued from the thread B, the second issuance interval suppressing unit 202 subsequently suppresses (prohibits) issuance of the issuance interval suppression instruction for a period of two machine cycles. In addition, when the issuance interval suppression instruction is issued from the thread C, the third issuance interval suppressing unit 203 subsequently suppresses (prohibits) issuance of the issuance interval suppression instruction for a period of two machine cycles. Thus, it is possible to suppress only the minimum essential instruction. This allows efficiently diverting a resource to another thread without decreasing execution efficiency.

In addition, it is assumed that the first execution interval specifying unit 204 specifies the execution cycle intervals such that the instructions in the thread A can be executed in the calculator group 119 once per two machine cycles. Likewise, it is assumed that the second execution interval specifying unit 205 specifies the execution cycle intervals such that the instructions in the thread B can be executed in the calculator group 119 once per two machine cycles. In addition, it is assumed that the third execution interval specifying unit 206 specifies the execution cycle intervals such that the instructions in the thread C can be executed in the calculator group 119 once per two machine cycles.

In addition, in terms of thread priority, the highest priority is assigned to the thread A, the second highest priority is assigned to the thread B, and the lowest priority is assigned to the thread C.

The following will describe an operation during a current machine cycle, assuming that: in a machine cycle immediately preceding the current machine cycle, the threads A and C are executed, and the issuance interval suppression instruction is issued from the thread A. Note that the following will describe the operation in a first turn, and to differentiate the first turn from a second turn that is to be described later, “−1” is assigned to a step number of each step to indicate that it is the first turn. At the beginning of the first turn, it is assumed that the down counter of each of the first issuance interval suppressing unit 201, the second issuance interval suppressing unit 202, the third issuance interval suppressing unit 203 is set to 0. In addition, it is assumed that the down counter of each of the first execution interval specifying unit 204, the second execution interval specifying unit 205, and the third execution interval specifying unit 206 is set to 0.

The thread selecting unit 114 obtains, from the instruction issuance control unit 115, execution statuses of the threads A and C executed in the previous machine cycle (Step S101-1). That is, the thread selecting unit 14 obtains information indicating whether or not the executed (issued) instructions in the threads A and C are issuance interval suppression instructions. Here, it is assumed that the thread selecting unit 114 has obtained the information indicating that the executed instruction of the thread A is the issuance interval suppression instruction.

Since the issuance interval suppression instruction from the thread A has been executed, the first issuance interval suppressing unit 201 sets the down counter of the first issuance interval suppressing unit 201 to 2 as the cycle number for suppressing issuance of the issuance interval suppression instruction (Step S102-1). In addition, since the threads A and C have been executed, the first execution interval specifying unit 204 and the third execution interval specifying unit 206 set the value of the down counters to 1.

Since the values of the down counters in the first execution interval specifying unit 204 and the third execution interval specifying unit 206 are 1, not 0, the thread selecting unit 114 determines that the threads A and C are not executable. In addition, since the value of the down counter in the second execution interval specifying unit 205 is 0, the thread selecting unit 114 determines that the thread B is executable. Thus, the thread selecting unit 114 selects only the thread B as the thread to be executed, and notifies the result to the instruction issuance control unit 115. In addition, the thread selecting unit 114 also notifies that the selected thread B has the highest priority (Step S103-1).

The instruction issuance control unit 115 determines the thread B as the thread to be executed, based on the priority information of the thread B that is notified from the thread selecting unit 114 and information indicating the result of the grouping of each of the instructions in the thread B which is performed by the second instruction grouping unit 109 (Step S104-1).

The instruction issuance control unit 115 transmits each of the instructions in the thread B from the second instruction grouping unit 109 to the calculator group 119, by manipulating the thread selector 116, and the thread register selectors 117 and 118, and the calculator group 119 executes each of the instructions in the thread B (Step S105-1).

Each of the first issuance interval suppressing unit 201, the second issuance interval suppressing unit 202, the third issuance interval suppressing unit 203, the first execution interval specifying unit 204, the second execution interval specifying unit 205, and the third execution interval specifying unit 206 decrements the value of the down counter by one (Step S106-1). At this time, when the value of the down counter is 0, the setting remains 0 without decrementing.

The processing in steps S101 to S106 above is performed for each machine cycle. A machine cycle after the machine cycle described above will subsequently be described following steps. Note that “−2” is assigned to a step number of each step to indicate that it is the second turn. Note that the following description is based on an assumption that the thread A is about to execute the issuance interval suppression instruction again.

The thread selecting unit 114 obtains, from the instruction issuance control unit 115, an execution status of the thread B executed in the previous machine cycle (Step S101-2). In other words, it is assumed that information indicating that the executed instruction of the thread B does not include the issuance interval suppression instruction is obtained.

Since the thread B is executed, the second execution interval specifying unit 205 sets the down counter to 1 (Step S102-2).

Since the value of the down counter of the second execution interval specifying unit 205 is 1, not 0, the thread selecting unit 114 determines that the thread B is not executable. In addition, since the values of the down counters in the first execution interval specifying unit 204 and the third execution interval specifying unit 206 are 0, the thread selecting unit 114 determines that the threads A and B are executable. Thus, the thread selecting unit 114 selects the threads A and C as the threads to be executed, and notifies the result to the instruction issuance control unit 115. In addition, the thread selecting unit 114 also notifies that the thread A has higher priority than the thread B. In addition, the value of the down counter of the first issuance interval suppressing unit 201 is 1. Thus, to prevent issuance of the issuance interval suppression instruction of the thread A, the thread selecting unit 114 notifies, in addition to the priority information, the instruction issuance control unit 115 that the issuance interval suppression instruction from the thread A should not be executed (Step S103-2).

Based on the priority information of the threads A and C and the information of the issuance interval suppression instruction that have been received from the thread selecting unit 114, and the information indicating the result of the grouping of the instructions in the threads A and C which is performed by the first instruction grouping unit 108 and the third instruction grouping unit 110, the instruction issuance control unit 115 determines the thread A as an inexecutable thread that is restricted by the issuance interval suppression instruction, and determines the thread C as the thread to be executed (Step S104-2).

The instruction issuance control unit 115 transmits each of the instructions in the thread C from the third instruction grouping unit 110 to the calculator group 119 by manipulating the thread selector 116, and the thread register selectors 117 and 118, and the calculator group 119 executes each of the instructions in the thread C (Step S105-2).

Each of the first issuance interval suppressing unit 201, the second issuance interval suppressing unit 202, the third issuance interval suppressing unit 203, the first execution interval specifying unit 204, the second execution interval specifying unit 205, and the third execution interval specifying unit 206 decrements the value of the down counter by one (Step S106-2). At this time, when the value of the down counter is 0, the setting remains 0 without decrementing.

Note that in the flowchart in FIG. 4, the processing is terminated by power off or resetting of the multithread processor 1.

As described above, with the multithread processor 1 according to the first embodiment of the present invention, even when there is competition between threads for a calculating resource, it is possible to prevent significant decrease in efficiency in locally executing a thread which is inferior in terms of priority among threads that is specified by a user or for implementing the multithread processor. In addition, it is possible to balance the number of instructions in each thread and the number of calculating resources, thus allowing efficient use of the calculating resources.

Note that the present embodiment assumes the number of the threads to be 3, but a variety of modifications are possible without being limited to this value, and it goes without saying that all these modifications are within the scope of the present invention.

In addition, the present embodiment assumes that a maximum of 3 instructions can be simultaneously issued, but a variety of modifications are possible without being limited to this value, and it goes without saying that all these modifications are within the scope of the present invention.

In addition, the present embodiment assumes that a maximum of 2 instructions can be simultaneously executed, but a variety of modifications are possible without being limited to this value, and it goes without saying that all these modifications are within the scope of the present invention.

In addition, the present embodiment assumes that a maximum of 4 calculators can simultaneously execute calculation, but a variety of modifications are possible without being limited to this value, and it goes without saying that all these modifications are within the scope of the present invention.

### Second Embodiment

Hereinafter, a compiler and an operating system according to a second embodiment of the present invention will be described with reference to the drawings.

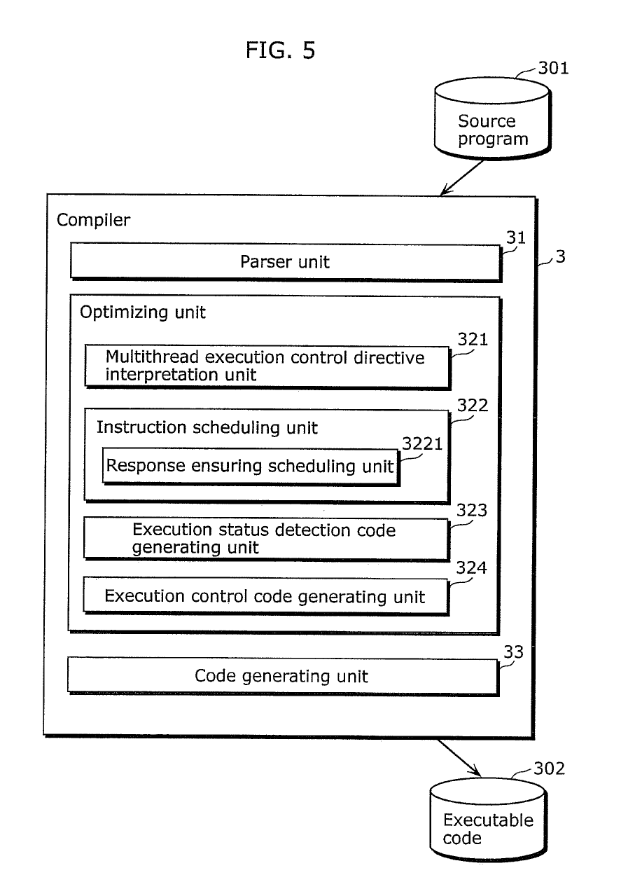

FIG. 5 is a block diagram showing a compiler 3 according to the second embodiment of the present invention.

The compiler 3 receives an input of the source program 301 that is written in C language by the programmer, and generates an executable code 302 for a target processor after converting the input into internal intermediate representation (intermediate code) and optimizing or allocating the calculating resources. The target processor of the compiler 3 is the multithread processor 1 described in the first embodiment.

The following will describe a detailed configuration of each constituent element of the compiler 3 according to the present embodiment and the operation thereof. Note that the compiler 3 is a program, and performs its function by executing the program for realizing each constituent element of the compiler 3 on a computer including a processor and a memory. It goes without saying that such a program can be distributed through a non-volatile recording medium such as a CD-ROM or a communication network such as the Internet.

The compiler 3 includes, as processing units which function when executed on the computer, a parser unit 31, an optimizing unit 32, and a code generating unit 33. The compiler 3, by causing the computer to function as these processing units, is capable of causing the computer to operate as a compiler apparatus.

The parser unit 31 performs lexical analysis and syntax analysis by extracting a reserved word (keyword) and so on, and converts each statement into an intermediate code based on a given rule.

The optimizing unit 32 performs optimization on the intermediate code that is input, such as redundancy elimination, instruction scheduling, or register allocation.

The code generating unit 33 converts, with reference to a conversion table and so on that are held therein, all the intermediate codes output from the optimizing unit 32 into machine language code. Thus, the executable code 302 is generated.

The optimizing unit 32 includes: a multithread execution control directive interpretation unit 321, an instruction scheduling unit 322, an execution status detection code generating unit 323, and an execution control code generating unit 324. The instruction scheduling unit 322 includes a response ensuring scheduling unit 3221.

The multithread execution control directive interpretation unit 321 accepts a directive, from the programmer, for controlling the multithread execution, as a compile option, a pragma instruction (#pragma), or an intrinsic function. The multithread execution control directive interpretation unit 321 stores the accepted directive in the intermediate code, and transmits the directive to the instruction scheduling unit 322 and so on in a subsequent stage.

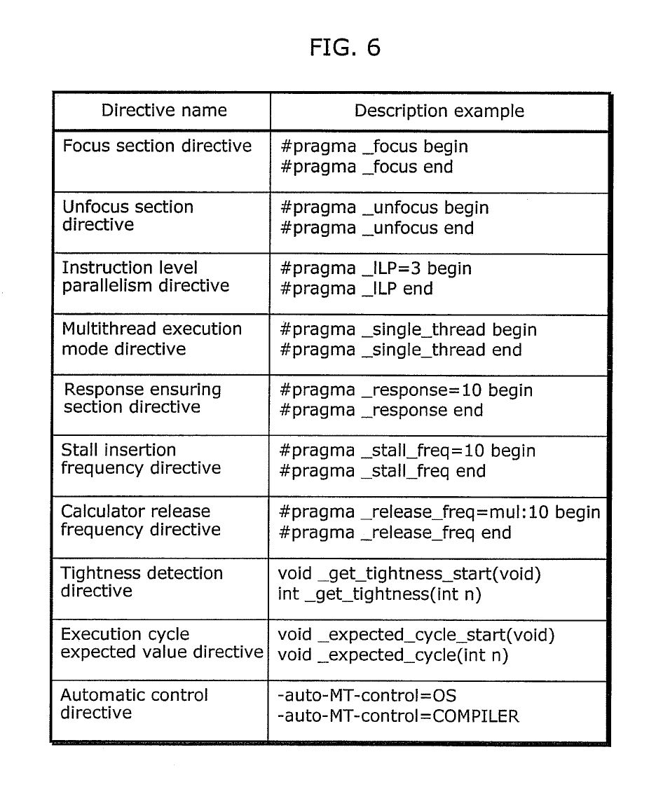

FIG. 6 is a diagram indicating a list of directives for multithread execution control that are received by the multithread execution control directive interpretation unit 321. The following will describe each of the directives shown in FIG. 6 with reference to an example of the source program 301 using the directives.

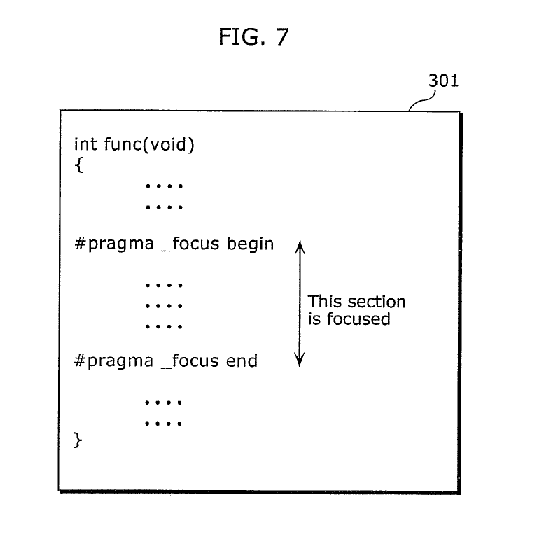

With reference to FIG. 7, a “focus section directive” is a directive which specifies a section to be more focused than the other threads in the source program 301 by enclosing the section with “#pragma_focus begin” and “#pragma_focus end”. According to the directive, the compiler 3 performs control such that the allocation of processor cycles and calculating resources is concentrated on the instructions included in this section.

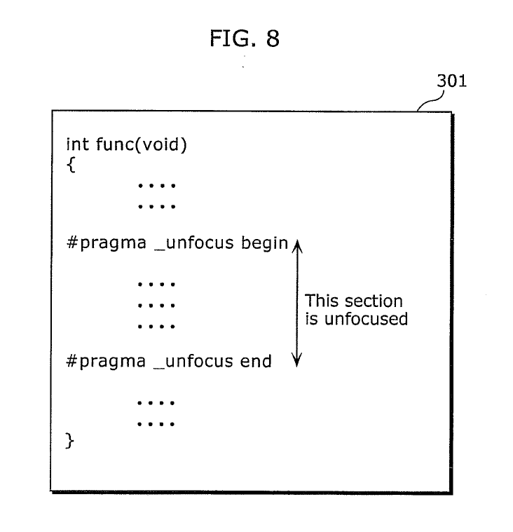

With reference to FIG. 8, an “unfocus section directive” is a directive which specifies a section that need not be particularly focused compared to the other threads, by enclosing the section with “#pragma_unfocus begin” and “#pragma_unfocus end”. According to the directive, the compiler 3 performs control such that the allocation of processor cycles and calculating resources is not particularly concentrated on the instructions included in this section.

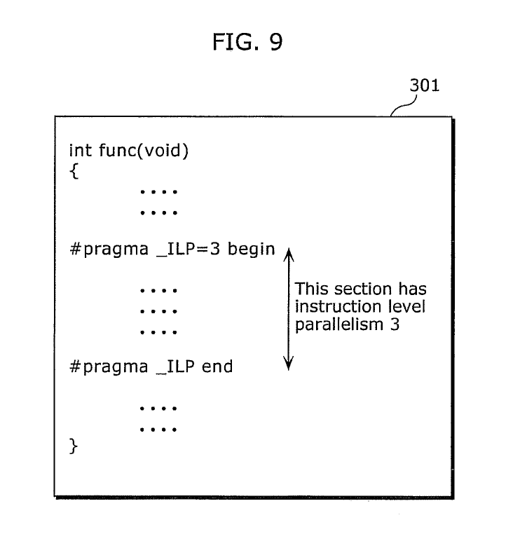

With reference to FIG. 9, an “instruction level parallelism directive” is a directive for specifying instruction level parallelism of a section enclosed with “#pragma ILP=‘num’ begin” and “#pragma ILP end”. The ‘num’ portion specifies one of the numbers from 1 to 3, and the compiler 3 generates a code for setting a specified operation and also performs instruction scheduling assuming the designated instruction level parallelism. FIG. 9 indicates the instruction level parallelism directive that specifies “3” as ‘num’. In other words, “3” is specified as the instruction level parallelism of the section enclosed with “#pragma ILP=3 begin” and “#pragma ILP end”.

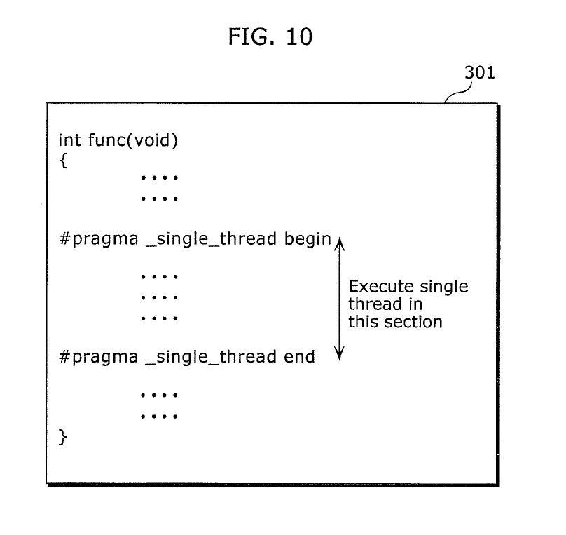

With reference to FIG. 10, a “multithread execution mode directive” is a directive for causing to operate, a section enclosed with “#pragma_single_thread begin” and “#pragma_single_thread end” in the source program 301, in a single thread mode for operating only in a current thread. According to the directive, the compiler 3 generates a code for setting the operation mode, that is, a code indicating 1 as the number of threads to be executed in the section above.

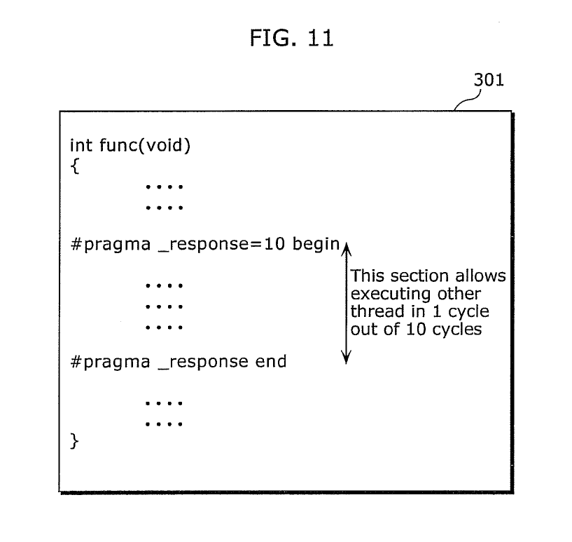

With reference to FIG. 11, a “response ensuring section directive” is a directive for specifying frequency which allows minimum response of another thread in a section enclosed with “#pragma_response=‘num’ begin” and “#pragma_response end”. The ‘num’ portion specifies a numerical value indicating once in at least how many cycles another thread should be executed, and the compiler 3 adjusts the generation code of the current thread to satisfy the specified condition. FIG. 11 indicates the response ensuring section directive that specifies “10” as ‘num’. More specifically, it is the directive for executing another thread in the section enclosed with “#pragma_response=10 begin” and “#pragma_response end”, in at least one cycle out of ten cycles, and the code is generated to satisfy this directive. For example, a code for inserting a stall cycle with constant frequency or a code for releasing a calculating resource with constant frequency is generated.

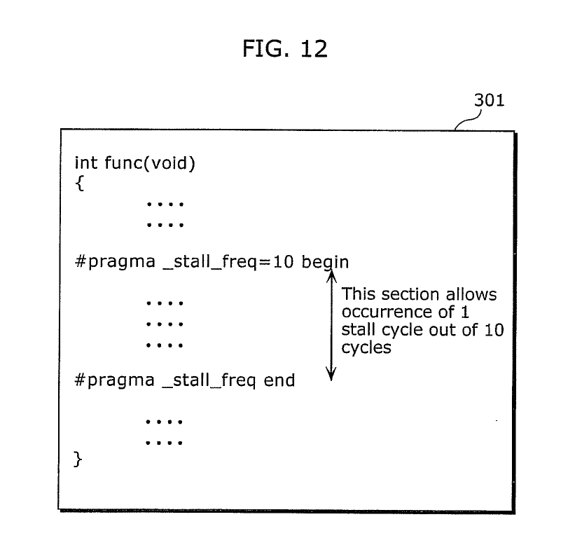

With reference to FIG. 12, a “stall insertion frequency directive” is a directive for specifying frequency with which at least one stall cycle occurs in a section in the source program 301, which is enclosed with “#pragma_stall_freq=‘num’ begin” and “#pragma_stall_freq end”. The ‘num’ portion specifies a numerical value to indicate once in at least how many cycles a stall should occur, and the compiler 3 inserts the stall cycle accordingly to satisfy the specified condition. FIG. 12 indicates the stall insertion frequency directive that specifies “10” as ‘num’. In other words, in the section enclosed with “#pragma_stall_freq=10 begin” and “#pragma_stall_freq end”, the code is generated such that at least one stall cycle occurs out of 10 cycles.

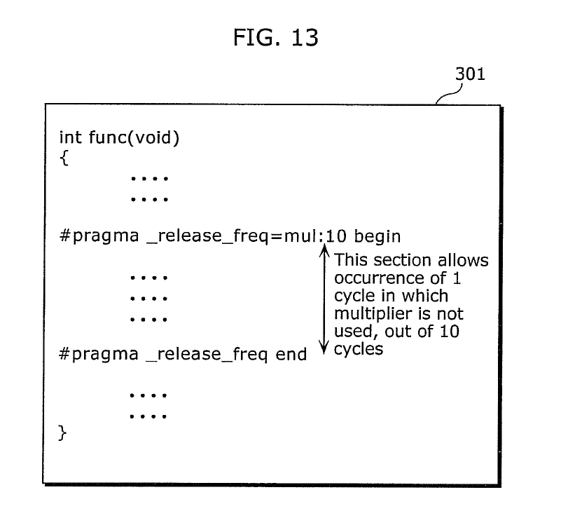

With reference to FIG. 13, a “calculator release frequency directive” is a directive for specifying frequency with which at least one unused cycle occurs in a specified calculator in a section in the source program 301 which is enclosed with “#pragma_release_freq=‘res’:‘num’ begin” and “#pragma_release_freq end”. In the ‘res’ portion, ‘mul’ or ‘mem’ can be specified as a type of the calculator, with ‘mul’ representing a multiplier and ‘mem’ representing a memory access device, respectively. The ‘num’ portion specifies once in at least how many cycles the unused cycle of the designated calculator should be caused to occur, and the compiler 3 adjusts the generation code to satisfy the specified condition. FIG. 13 shows a calculator release frequency directive which specifies “mul” as ‘res’, and “10” as ‘num’. In other words, in the section enclosed with “#pragma_release_freq=mul:10 begin” and “#pragma_release_freq end”, the code is generated such that, out of 10 cycles, at least one cycle occurs in which the multiplier that is the specified calculator is not used.

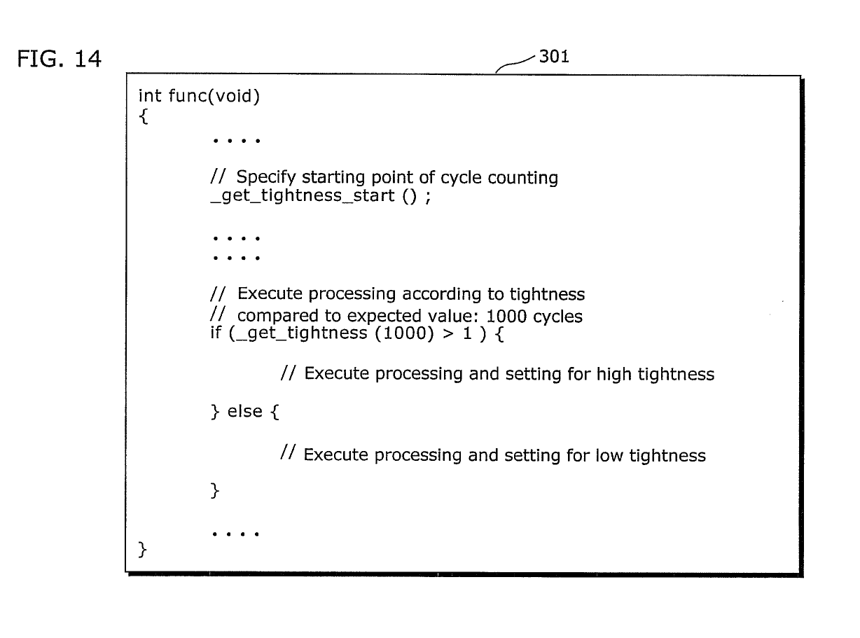

With reference to FIG. 14, a “tightness detection directive” is a set of intrinsic functions for detecting a degree of tightness with respect to the number of expected execution cycles. A function_get_tightness_start( ) specifies a starting point of a cycle number measurement section in the source program 301. According to a function_get_tightness(num), tightness can be obtained. “num”, which is an argument, specifies an expected value or a value to be ensured of the execution cycle number from the starting point, and the function returns a ratio of the number of actual execution cycles with respect to the specified value. FIG. 14 indicates the tightness detection directive that specifies “1000” as ‘num’. With this, when n is the actual number of execution cycles, the function_get_tightness(1000) returns n/1000.

In addition, the function allows the programmer to obtain the tightness of processing, thus enabling programming of control according to the tightness. For example, when the tightness is larger than 1, the calculating resources may be decreased, or the code for decreasing the instruction level parallelism may be generated. In addition, when the tightness is smaller than 1, the calculating resources may be increased, or the code for generating the instruction level parallelism may be generated.

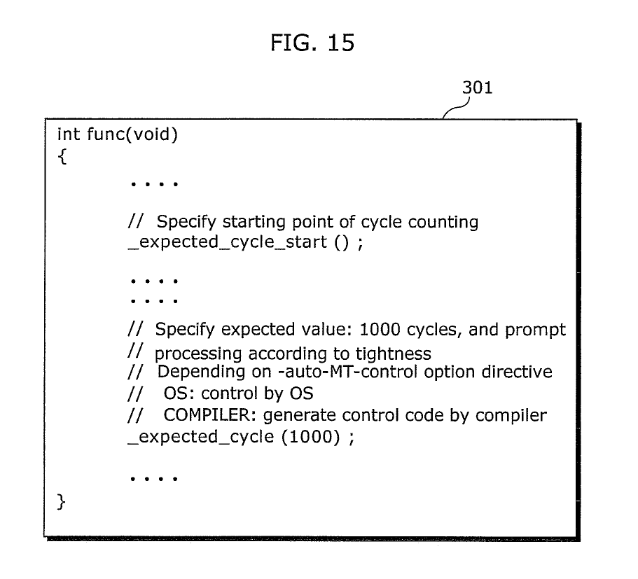

With reference to FIG. 15, an “execution cycle expected value directive” is a set of intrinsic functions for directing the number of expected execution cycles. A function_expected_cycle_start( ) specifies a starting point of the cycle number measurement section in the source program 301. A function_expected_cycle(num) specifies the expected value of the number of execution cycles. “num”, which is an argument, specifies an expected value or a value to be ensured of the execution cycle number from the starting point. The expected value, specified by the programmer using this function, allows the compiler 3 or an operating system 4 to derive the tightness of the actual processing, and to automatically perform appropriate control of the number of execution cycles.

An “automatic control directive” is a compile option which directs performance of automatic multithread execution control. An −auto-MT-control=OS option directs automatic control by the operating system 4, and an −auto-MT-control=COMPILER option directs automatic control by the compiler 3.

Again, with reference to FIG. 5, the instruction scheduling unit 322 performs optimization to improve execution efficiency by appropriately rearranging a group of instructions that are input while retaining dependency between the instructions. Note that the rearrangement of the instructions is performed assuming the parallelism of the instruction level. In the directives described above, the section specified by the “focus section directive” assumes the parallelism to be 3, the section specified by the “unfocus section directive” assumes the parallelism to be 1, and the section specified by the “instruction level parallelism directive” assumes the parallelism according to the directive. The level parallelism is assumed to be 3 by default.

In addition, in the section specified by the “multithread execution mode directive”, an instruction scheduling is performed assuming that only the current thread is operating on the multithread processor without presence of any other thread.

The instruction scheduling unit 322 includes the response ensuring scheduling unit 3221.

The response ensuring scheduling unit 3221 serially performs a search on cycles, starting from the top, in the section specified by the “response ensuring section directive” or “stall insertion frequency directive” described earlier, and when a series of cycles in which the same number of stalls as the specified value do not occur is detected, the response ensuring scheduling unit 3221 inserts a “nop” instruction for generating a stall, and continues the search from the next instruction. This allows another thread to be executed in at least one cycle out of the specified number of cycles without fail.

In addition, with the section specified by the “calculator release frequency directive”, when performing instruction scheduling, the cycle for using the specified calculator is counted, and when the count reaches a specified value, scheduling is performed assuming that the calculator cannot be used in the next cycle. When the cycle in which the calculator is not used occurs, the count is reset. This allows using the calculator for another thread in at least one cycle out of the specified number of cycles.

The execution status detection code generating unit 323 inserts a code for detecting the execution status in response to the directive described earlier.

Specifically, in response to the “tightness detection directive” described earlier, a system call for starting cycle counting for the multithread processor is inserted at a portion at which the function_get_tightness_start( ) is written. Then, at a portion at which the function_get_tightness(num) is written, the following are inserted: the system call for reading the cycle count of the multithread processor; and a code that returns, as tightness, a value obtained by dividing the read-out count value by the expected value assigned as num. This returned value allows the programmer to know the tightness of the processing.

In addition, in response to the “execution cycle expected value directive” described earlier, a system call for starting cycle counting for the multithread processor is inserted at a portion at which the function_expected_cycle_start( ) is written. It is possible to perform cycle counting independently according to each of the directives.

Then, in the case of an operating system specified as a compile option −auto-MT-control of an automatic control directive, a system call for prompting execution control is inserted at a portion in which the function_expected_cycle(num) is written, by transmitting, to the operating system 4, the expected value of the number of execution cycles that is indicated by the “num”. Accordingly, it is possible to perform execution control in the operating system 4.

In addition, in the case of COMPILER specified as a compile option −auto-MT-control of an automatic control directive, a system call for reading the cycle count of the multithread processor is inserted at a portion in which the function_expected_cycle(num) is written, the tightness is calculated by dividing the read-out count value by the expected value assigned as num, and a code for performing control corresponding to the “focus section” as described later when the tightness is 0.8 or above, and performing control corresponding to the “unfocus section” as described later when the tightness is below 0.8. This allows automatically generating, in the compiler, the code for performing the multithread execution control according to the tightness.

The execution control code generating unit 324 inserts a code for controlling execution according to each of the directives described earlier.

Specifically, in response to the “focus section directive”, a system call for setting the instruction level parallelism to 3 is inserted at a “begin” portion of the section, and a system call for resetting is inserted at an “end” portion of the section.

In addition, in response to the “unfocus section directive”, a system call for setting the instruction level parallelism to 1 and a code for setting an execution mode in which the cycle of another thread does not interrupt are inserted at a “begin” portion of the section, and a system call for resetting is inserted at an “end” portion of the section.

Furthermore, in response to the “instruction level parallelism directive”, a system call for setting the instruction level parallelism to a specified value is inserted at a “begin” portion of the section, and a system call for resetting is inserted at an “end” portion of the section.

In addition, in response to the “multithread execution mode directive instruction level parallelism directive”, a system call for shifting to a single thread mode is inserted at a “begin” portion of the section, and a system call for resetting is inserted at an “end” portion of the section.

Then, in response to the “execution cycle expected value directive” and the “automatic control directive”, a code for performing the same control as in the “unfocus section” or “focus section” according to the detected tightness as described above is inserted.

Adopting the configuration of the compiler 3 as described above allows performing, in the multithread processor 1, controlling the execution mode of the thread as well as usage of the processor resources, thus allowing, accordingly, focusing on the processing of the current thread or sharing the processor resources with another thread. In addition, even when the processing is focused on the current thread, it is possible to ensure predetermined response for another thread. In addition, it is also possible to obtain information on the number of execution cycles for actual execution, and to perform, based on the information, the control described above according to the tightness, thus allowing fine performance tuning and increasing use efficiency of the multithread processor.

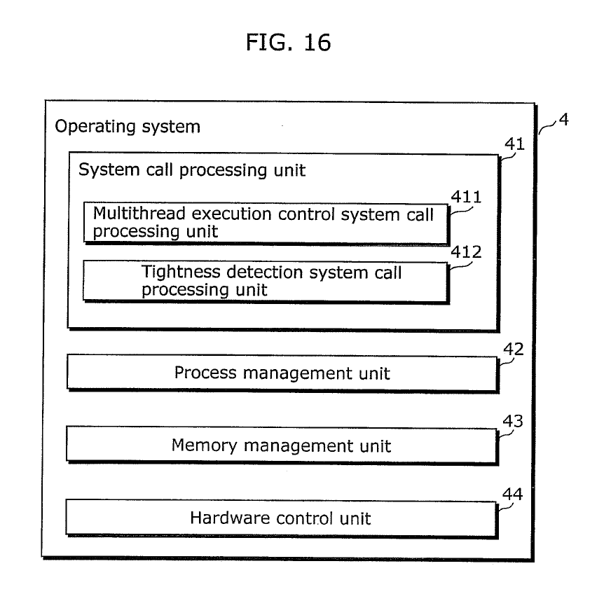

FIG. 16 is a block diagram showing the operating system 4 according to the second embodiment of the present invention.

The operating system 4 includes, as processing units which function when executed on a computer, a system call processing unit 41, a process management unit 42, a memory management unit 43, and a hardware control unit 44. Note that the operating system 4 is a program, and performs its function by executing the program for realizing each constituent element of the operating system 4 on the computer including a processor and a memory. It goes without saying that such a program can be distributed through a non-volatile recording medium such as a CD-ROM or a communication network such as the Internet. The operating system 4, by causing the computer to function as these processing units, is capable of causing the computer to operate as an operating system apparatus. Note that the multithread processor operated by the operating system 4 is the multithread processor 1 shown in the first embodiment.

The process management unit 42 gives priority to a plurality of processes operating on the operating system 4, determines, based on the priority, time to be allocated to each process, and controls the switching of the processes and so on.

The memory management unit 43 performs control such as management of available portions in the memory, allocation and release of the memory, and swap of a main memory and a secondary memory.

The system call processing unit 41 provides processing corresponding to the system call that is a kernel service for an application program.

The system call processing unit 41 includes a multithread execution control system call processing unit 411 and a tightness detection system call processing unit 412.

The multithread execution control system call processing unit 411 performs processing on the system call for controlling the multithread operation of the multithread processor.

Specifically, the multithread execution control system call processing unit 411 accepts a system call for setting the instruction level parallelism of the execution control code generating unit 324 of the compiler 3 described earlier, and sets the instruction level parallelism of the multithread processor as well as holding an original instruction level parallelism. Then, the multithread execution control system call processing unit 411 accepts the system call for resetting the instruction level parallelism to the original instruction level parallelism, and sets the multithread processor to the original instruction level parallelism that is held. Furthermore, the multithread execution control system call processing unit 411 accepts the system call for shifting to the single thread mode, and sets the operation mode of the multithread processor to the single thread mode as well as holding an original thread mode. Then, the multithread execution control system call processing unit 411 accepts the system call for resetting the mode to the original instruction level parallelism, and sets the multithread processor to the original thread mode that is held.

The tightness detection system call processing unit 412 performs processing on the system call for detecting and dealing with the tightness of the processing.

Specifically, the tightness detection system call processing unit 412 accepts the system call for starting cycle counting for the multithread processor in the execution status detection code generating unit 323 in the compiler 3 described earlier, and performs setting for obtaining a counter value of the multithread processor and starting the counting. In addition, the tightness detection system call processing unit 412 accepts the system call for reading a current cycle count, reads a current count value of a corresponding counter in the multithread processor, and returns the value. Furthermore, the tightness detection system call processing unit 412 accepts the system call for prompting the execution control by transmitting the expected value of the number of execution cycles, reads the current count value of the corresponding counter in the multithread processor, derives tightness form the value and the expected value of the number of execution cycles that is transmitted, and performs execution control according to the tightness. When the tightness is high, the tightness detection system call processing unit 412 gives increased priority to the process and performs control corresponding to the “focus section” as described earlier. On the other hand, when the tightness is low, the tightness detection system call processing unit 412 gives decreased priority to the process and performs control corresponding to the “unfocus section” as described earlier.

The hardware control unit 44 performs register setting and reading for hardware control required by the system call processing unit 41 and so on.

Specifically, The hardware control unit 44 performs the register setting of the hardware and reading for, as described earlier, setting and return of the instruction level parallelism, setting and return of the multithread operation mode, initialization of the cycle counter, and reading of the cycle counter.

Adopting the configuration of the operating system 4 as described above allows operation control of the multithread processor from the program, thus allowing appropriately allocating the processor resources to each program. In addition, it is also possible to automatically perform appropriate control by detecting tightness from an input of the expected value of the number of execution cycles that is assumed by the programmer and information on the actual execution cycle that is read from the hardware, thus allowing reducing a burden of tuning on the programmer.

It goes without saying that the present invention is not limited to the embodiments above but allows various modifications and variations, and all such modifications and variations should be included in the scope of the present invention. For example, the following variations can be considered.

(1) The compiler according to the second embodiment above has been assumed as a compiler system for C language, but the present invention is not limited to C language. The present invention holds significance even in the case of adopting another programming language.

(2) The compiler according to the second embodiment above has been assumed as a compiler system for high-level language, but the present invention is not limited to this. For example, the present invention is applicable likewise to an assembler which receives an assembler program as an input.

(3) In the second embodiment above, as the target processor, a processor capable of issuing three instructions for one cycle and simultaneously operating three threads in parallel has been assumed, but the present invention is not limited to such numbers of instructions and threads to be simultaneously issued.

(4) In the second embodiment above, a superscalar processor has been assumed as the target processor, but the present invention is not limited to this. The present invention is also applicable to a very long instruction word (VLIW) processor.

(5) In the second embodiment above, each of the pragma directive, the intrinsic function, and the compile option has been defined as a method of providing directives to the multithread execution control directive interpretation unit, but the present invention is not limited to such definition. What is defined as the pragma directive may be realized by the intrinsic function, and the opposite is also possible. In addition, in the case of an assembler program, it is possible to give directives as pseudo-instructions.

(6) In the second embodiment above, the instruction level parallelism directive to be provided to the multithread execution control directive interpretation unit has been assumed to be 1 at minimum and 3 at maximum in terms of the number of processors, but the present invention is not limited to this specification. The parallelism may be specified as 2 or the like that is an intermediate level of capability of the multithread processor.

(7) In the second embodiment above, frequency represented by the cycle number has been provided as the response ensuring section directive, the stall insertion frequency directive, and the calculator release directive that are to be provided to the multithread execution control directive interpretation unit, but the present invention is not limited to this specification. These directives may be given in units of time such as milliseconds, or in levels such as high, middle, and low.

(8) In the second embodiment above, a multiplier or a memory access device has been assumed as the calculator specified by the calculator release frequency directive provided to the multithread execution control directive interpretation unit, but the present invention is not limited to this directive. Another calculator may be directed, or the directive may be given on a more detailed basis, such as separating load from storage.

(9) In the second embodiment above, the expected value represented by the number of cycles has been provided as the tightness detection directive and the execution cycle expected value directive that are to be provided to the multithread execution control directive interpretation unit, but the present invention is not limited to these directives. The directive may be given in units of time such as milliseconds, or in levels such as high, middle, and low.

(10) In the operating system according to the second embodiment above, a general-purpose operating system which involves process management and memory management has been assumed, but the operating system may also be a device driver or the like which has a narrower function. Such variations further allow performing appropriate control of the hardware through an application programming interface (API).

Furthermore, each of the embodiments and variations above may be combined together.

The embodiments disclosed above should not be considered as limitative but be considered as illustrative in all aspects. Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

As described above, a multithread processor according to an implementation of the present invention prevents, even when there is competition between threads for a calculating resource, significant decrease in efficiency in locally executing a thread which is inferior in priority among threads that is designated by a user or determined in implementation of the multithread processor, and produces an advantageous effect of allowing balancing the number of instructions in each thread and the number of calculating resources and efficiently executing the threads, and is applicable as a multithread processor and an application software using the multithread processor, and so on.

What is claimed is:

1. A multithread processor for executing, in parallel, instructions included in a plurality of threads, said multithread processor comprising:
a plurality of calculators each of which is for executing an instruction;
a grouping unit configured to classify, for each of the threads, the instructions included in the thread into groups each of which includes instructions that are simultaneously executable by said calculators;
a thread selecting unit configured to select, per execution cycle of said multithread processor, a thread including instructions to be issued to said calculators, from among the threads, by controlling execution frequency of executing the instructions included in the threads; and
an instruction issuing unit configured to issue, to said calculators, per execution cycle of said multithread processor, the instructions classified into each of the groups by said grouping unit and being among the instructions included in the thread selected by said thread selecting unit.

2. The multithread processor according to claim 1, further comprising
an instruction number specifying unit configured to specify, for each of the threads, a maximum number of instructions to be classified into each of the groups by said grouping unit,
wherein said grouping unit is configured to classify the instructions into each of the groups such that the number of the instructions in each of the groups does not exceed the maximum number of instructions that is specified by said instruction number specifying unit.

3. The multithread processor according to claim 2,
wherein said instruction number specifying unit is configured to specify the maximum number of instructions according to a value that is set for a register.

4. The multithread processor according to claim 2,
wherein said instruction number specifying unit is configured to specify the maximum number of instructions according to an instruction for specifying the maximum number of instructions to be included in the threads.

5. A multithread processor according to claim 1,
wherein said thread selecting unit includes an execution interval specifying unit configured to specify, for each of the threads, an execution cycle interval for executing the instructions in said calculators, and is configured to select each of the threads according to the execution cycle interval specified by said execution interval specifying unit.

6. The multithread processor according to claim 5,
wherein said execution interval specifying unit is configured to specify the execution cycle interval according to a value that is set for a register.

7. The multithread processor according to claim 5,
wherein said execution interval specifying unit is configured to specify the execution cycle interval in accordance with an instruction for specifying the execution cycle interval, the instruction being included in each of the threads.

8. The multithread processor according to claim 1,
wherein said thread selecting unit includes an issuance interval suppressing unit configured to suppress a thread from which an instruction causing competition between more than one thread for at least one of said calculators has been issued, so as to inhibit execution of the instruction during a given number of execution cycles.

9. A compiler apparatus which is for converting a source program into an executable code and is used for a multithread processor which executes, in parallel, instructions included in a plurality of threads, said compiler apparatus comprising:
a directive obtaining unit configured to obtain a directive for multithread control from a programmer; and
a control code generating unit configured to generate, according to the directive, a code for controlling an execution mode of the multithread processor.

10. The compiler apparatus according to claim 9,
wherein said directive obtaining unit is configured to obtain a directive for focusing on parallel execution.

11. The compiler apparatus according to claim 9,
wherein said directive obtaining unit is configured to obtain a directive for not focusing on parallel execution.

12. The compiler apparatus according to claim 10,
wherein said control code generating unit is configured to generate, according to the directive, a code for increasing or decreasing the number of calculators.

13. The compiler apparatus according to claim 9,
wherein said directive obtaining unit is configured to obtain a directive for instruction level parallelism, and
said control code generating unit is configured to generate a code for executing each of the threads according to the instruction level parallelism.

14. The compiler apparatus according to claim 9,
wherein said directive obtaining unit is configured to obtain a directive for the number of threads to be executed.

15. The compiler apparatus according to claim 14,
wherein said directive obtaining unit is configured to obtain a directive for single thread execution.

16. The compiler apparatus according to claim 14,
wherein said control code generating unit is configured to generate, according to the directive, a code for controlling the number of threads to be executed.

17. The compiler apparatus according to claim 9,
wherein said directive obtaining unit is configured to obtain a directive for ensuring thread response.

18. The compiler apparatus according to claim 9,
wherein said directive obtaining unit is configured to obtain a directive for occurrence frequency of a stall cycle.

19. The compiler apparatus according to claim 9,
wherein said directive obtaining unit is configured to obtain a directive for release of a calculating resource.

20. The compiler apparatus according to claim 17,
wherein said control code generating unit is configured to generate, according to the directive, a code for inserting a stall cycle with a regular frequency.

21. The compiler apparatus according to claim 17,
wherein said control code generating unit is configured to generate, according to the directive, a code for releasing a calculating resource with a regular frequency.

22. The compiler apparatus according to claim 9,
wherein the directive specifies a given section included in the source program.

23. A compiler apparatus which is for converting a source program into an executable code and is used for a multithread processor which executes, in parallel, instructions included in a plurality of threads, said compiler apparatus comprising
an interface for detecting tightness of processing.

24. The compiler apparatus according to claim 23,
wherein said interface indicates a starting point of cycle counting.

25. The compiler apparatus according to claim 23,
wherein said interface is for input of an expected value of the number of cycles at a measurement point of the tightness.

26. The compiler apparatus according to claim 25,
wherein said interface returns the tightness that is derived from the expected value and an actual number of cycles.

27. The compiler apparatus according to claim 23, further comprising
a code generating unit configured to generate a code for executing processing according to the tightness.

28. The compiler apparatus according to claim 27,
wherein said code generating unit is configured to generate a code for increasing or decreasing calculating resources according to the tightness.

29. The compiler apparatus according to claim 27,
wherein said code generating unit is configured to generate a code for increasing or decreasing instruction level parallelism according to the tightness.

30. The compiler apparatus according to claim 23,
wherein said interface is realized by an intrinsic function in said compiler apparatus.

31. An operating system apparatus for a multithread processor which executes, in parallel, instructions included in a plurality of threads, said operating system apparatus comprising
a system call processing unit configured to process a system call which allows controlling an execution mode of the multithread processor, according to a directive for multithread control from a programmer.

32. The operating system apparatus according to claim 31,
wherein the system call relates to instruction level parallelism.

33. The operating system apparatus according to claim 31,
wherein the system call relates to the number of threads to be executed.

34. The operating system apparatus according to claim 31,
wherein the system call relates to cycle counting.

35. The operating system apparatus according to claim 31,
wherein the system call is for performing processing according to tightness.
